(19) United States
(12) Patent Application Publication
(10) Pub. No.: US 2023/0277286 A1
(43) Pub. Date: Sep. 7, 2023

(54) Micro Scale Mist Mouthguard Cleaning Device

(71) Applicant: THE UNIVERSITY OF HONG KONG, Hong Kong (CN)

(72) Inventors: Kit Hon Tsoi, Kowloon (CN); Chi Yan Lo, Hong Kong (CN); Ka Keung Mang, Hong Kong (CN); Tze Long Ip, Hong Kong (CN)

(73) Assignee: THE UNIVERSITY OF HONG KONG, Hong Kong (CN)

(21) Appl. No.: 18/157,725

(22) Filed: Jan. 20, 2023

Related U.S. Application Data
(60) Provisional application No. 63/304,368, filed on Jan. 28, 2022.

(51) Int. Cl. A61C 17/02; A61C 17/022

(52) U.S. Cl. CPC A61C 17/0211; A61C 17/022; B33Y 80/00

(57) ABSTRACT

A micro-scale mist teeth cleaning device includes console creating air under pressure and water under pressure. The console is connected to a mouthguard that is in the form of an outer ridge and an inner ridge with space in between for the teeth of a patient. The mouthguard includes a receptor for receiving the air and water under pressure, and has tubes for separately distributing the air under pressure and the water under pressure along the outer and inner ridges. The mouthguard further includes openings along the inner side of the outer ridge and the outer side of the inner ridge facing the location of the patient’s teeth when the mouthguard is installed in the patient’s mouth. The tubes for the pressurized air and the water intersect at each opening at an angle such that they act to eject a micro-scale mist from the opening onto the user’s teeth, thereby providing initial dental plaque removal.

### CROSS-REFERENCE TO RELATED APPLICATION

The present application claims the benefit of priority to U.S. provisional Pat. application serial No. 63/304,368 filed Jan. 28, 2022, which is hereby incorporated herein by reference in its entirety.

### FIELD OF THE INVENTION

The present invention relates to the cleaning of the teeth of aged and disabled people and, more particularly, to spraying a micro-scale mist onto the teeth in order to clean them.

### BACKGROUND OF THE INVENTION

Elderly and disable people may not brush their teeth at all or thoroughly enough to maintain their oral hygiene. This may be due to inattention or physical limitations. Thus, in order to avoid disease conditions, their care givers may have to brush their teeth for them.

The article by Hihara et al., “Effectiveness and safety of a new dental plaque removal device utilizing micro mist spray for removing oral biofilm in vitro,” BMC Oral Health (2021) 21:286 describes the removal of oral biofilm from the oral mucosa in order to prevent the risk of respiratory and gastrointestinal infection in elderly people. A Micro Scale Mist UNIT (MSM-UNIT) is proposed for removing dental plaque utilizing high speed sprays of fine water droplets. The MSM-UNIT proved to have significantly better results than a conventional air ablation device, yet this is a device for dentist use that has only one outlet.

In the article by Uehara et al., “Removal Mechanism of Artificial Dental Plaque by Impact of Micro-Droplets,” ECS Journal of Solid State Science and Technology 2162-8777 (January 2019) there is disclosed a mechanistic evaluation of the impact of a single water droplet on a model of artificial dental plaque used as a biofilm. The outlet has a water nozzle which is parallel with two air nozzles, and the handpiece for the outlet needs to be held at a 60° orientation with 8 mm distance from the surface in order to achieve its functional purpose. The instantaneous moment of the impact of the droplet on the biofilm was visualized using a high-speed imaging techniques.

Korean application KR10-1995572 B1 discloses the use of pulsed water to generated so-called water bubbles outside of a mouth guard that simultaneously covers a full set of teeth, both upper and lower. Such full mouth guards pose a choking hazard for elderly patients, especially when water bubbles are used.

U.S. Pat. No. 6,199,773 of Holt et al. discloses fluid and air nozzle assemblies capable of propelling streams of a cleaning fluid and air mixture onto a vehicle headlight. The fluid and air are mixed outside of the nozzle opening.

It would be of great benefit to have a device that could at least partially treat the teeth of aged or disabled people so as to improve their health and also help to reduce the workload of their care takers.

### SUMMARY OF THE INVENTION

The present invention is directed to the removal of preliminary plaque from the teeth of elderly and disable persons who may not brush their teeth thoroughly enough to maintain their oral hygiene by spraying micro-scale mist on to their teeth through a mouthguard or end effector device with multiple outlets. This may also help to reduce the workload of their care takers. Since the amount of water used is minimal, a suction source is not needed. Thus, the potential risk of choking, which may lead to fatal pneumonia of the elderly caused by water accidentally getting into their trachea, is reduced.

According to one embodiment of the present invention a device is provided for precise initial dental plaque removal from the teeth of aged and disabled people with a minimal amount of water. The device includes: a console for a user to adjust the flow of micro-scale mist, and a mouthguard or end effector, where the micro scale mist is generated. The mouthguard is placed into the mouth of the aged or disabled person for initial dental plaque removal.

The mouthguard has multiple outlets to deliver the micro-scale mist. The number of outlets depends on the patient’s oral condition, i.e., in ideal cases there will be an outlet aimed at certain plaque accumulating areas on each tooth, such as the interdental and gumline junction. Water and air channels are built into the mouthguard to deliver water and air to each of the outlet.

The outlet design of the mouthguard to generate micro scale mist is a key element of present invention. It depends on the angle at which the air and water streams intersect at the openings in the mouthguard to form the micro-scale mist.

### BRIEF DESCRIPTION OF THE DRAWINGS

The foregoing and other objects and advantages of the present invention will become more apparent when considered in connection with the following detailed description and appended drawings in which like designations denote like elements in the various views, and wherein:

FIG. 1A is a photo showing a console and two mouthguards making up the device of the present invention, FIG. 1B is a close up of one mouthguard showing tubes that deliver pressurized water and air to the mouthguard, and FIG. 1C shows the rear panel of the console with the water and air outlets to the tubes;

FIG. 2 is a top, front, right side perspective view of a mouthguard according to the present invention;

FIG. 3 is a top, front, left side perspective view of the mouthguard according to the present invention;

FIG. 4 is a bottom, front, left side perspective view of the mouthguard according to the present invention showing the air and water channel structure;

FIG. 5 is an enlarged view of the intersection of an air channel and a water channel at a mouthguard opening forming a micro-scale mist; and

FIG. 6A is a top, front, left side perspective view of the mouthguard with a stand or handle and FIG. 6B is a bottom, front, left side perspective view of the mouthguard with a stand or handle.

### DETAILED DESCRIPTION OF THE INVENTION

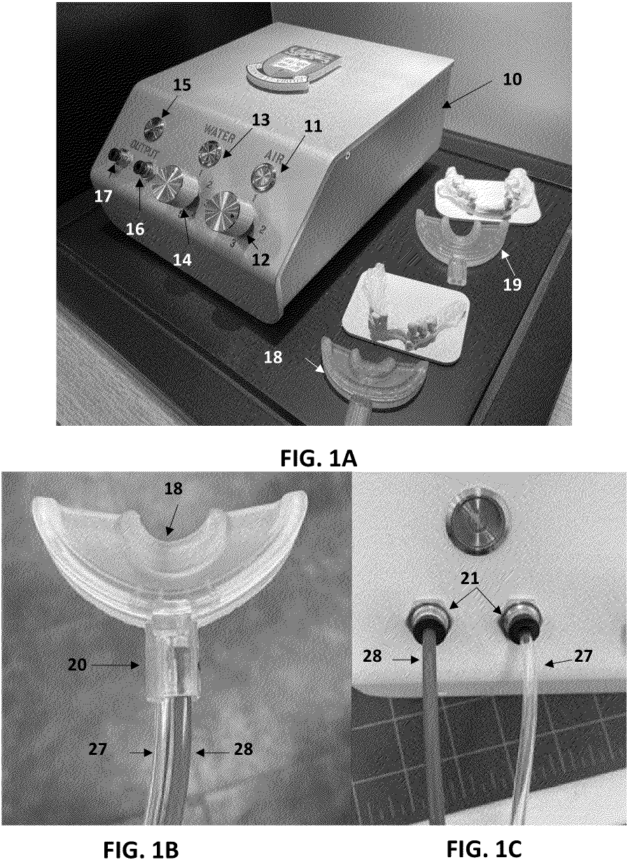

The basic elements of the present invention, which form a micro-scale mist mouthguard cleaning system, are shown in FIG. 1A. They include a console with an interior generator of air under pressure and a generator of water under pressure in a housing 10. The air pressure generator, which may be a conventional diaphragm pump (not shown), can be turned on or off by means of a push button 11 located to the right on a sloped front face of the housing 10. The amount of air pressure is controlled by a knob 12 below the button 11 on the sloped front face of the housing 10. The water pressure generator, which may be a conventional peristaltic pump (not shown), can be turned on or off by means of a push button 13 located in the center of the sloped front face. The amount of water pressure is controlled by a knob 14 below the button 13. An output push button 15 to the left on the sloped front face controls the combined output of the air and water generators, while push buttons 16 and 17 individually control the air A and water W, respectively.

Next to the housing 10 in FIG. 1A are two examples 18 & 19 of the mouthguard of the present invention. Arranged next to each mouthguard is a dental mold on which the invention can be tested. Although not shown in FIG. 1A, FIGS. 1B and 1C show two channel tubes 27, 28 that extend from outlets 21 on the rear panel of the housing 10 to a receptor 20 on the mouthguard 18 that is in use. The light colored channel tube 27 carries pressurized air and the dark colored channel tube 28 separately carries pressurized water.

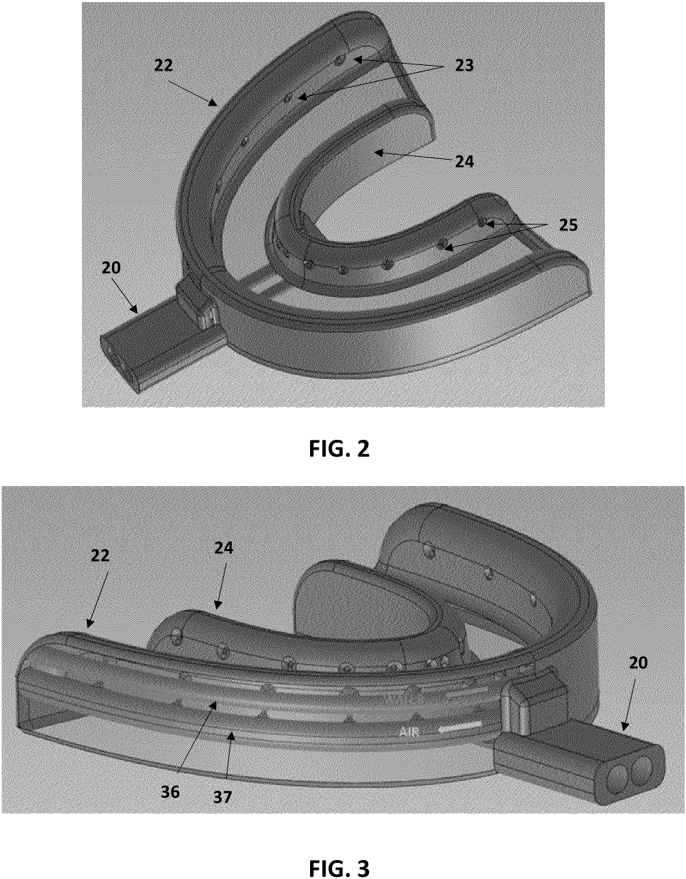

An enlarged top perspective view of one of the mouthguard 18 is shown in FIG. 2. It has an outer semicircular ridge 22 and an inner semicircular ridge 24 designed so that a person’s teeth can be located between the two ridges along the entire dental arch. There are openings 23, 25 in the inner side of the outer ridge and the outer side of the inner ridge where the spray exits the mouthguard and is directed onto critical areas of the teeth of the user.

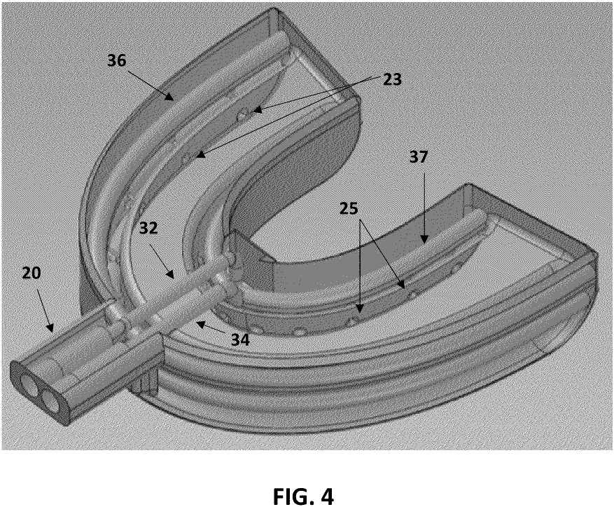

The receptor 20 is located at the front of outer ridge 22. As can be seen in FIG. 2, the receptor 20 has two holes in it that connect to the air and water channel tubes 27, 28 from the console. As shown in FIG. 3 each ridge contains separate internal channels, for example channel 36 for water and channel 37 for air, located one above the other. The connection from the receptor 20 to the inner ridge 24 is by means of tubes 32, 34 as can be seen in FIG. 4. Channels 36 extends the entire length of the outer ridge 22. Channel 37 extends the entire length of the inner ridge. There are two of each, one for air and one for water, located one above the other in both ridges 22, 24 as shown in FIGS. 3 and 4.

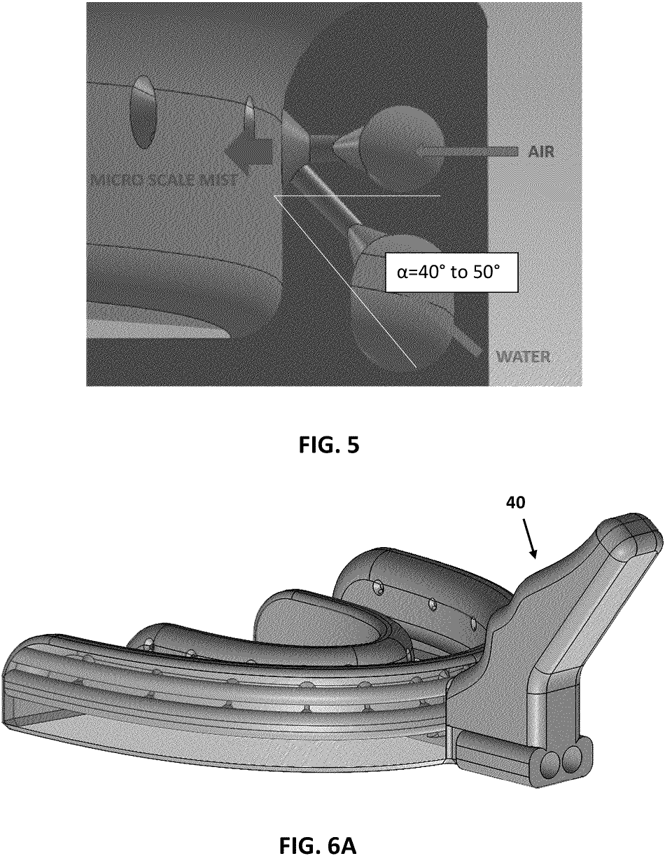

The micro-scale mist is generated at each of the outlets. In order for this to occur, it is critical to have the intersection angle α between the two channels (air and water) at the micro-mist outlet to be between 40° and 50°. This angular arrangement is shown in FIG. 5. Once combined, the pressurized air and water create a micro-scale mist that is ejected from openings 23 on the outer ridge and 25 on the inner ridge to contact the teeth of the patient. As a result, the mist ejected from the outlet can be effective at very close contact distance such as 1-4 mm from the outlet to the tooth/gum.

Thus, the multiple outlets 23, 25 of the mouthguard deliver the micro-scale mist to the teeth. The quantity of spray or mist at each outlet is adjusted with knobs 12, 14 based on the patient’s oral condition. The outlets 23, 25 are aimed at certain plaque accumulating areas of each tooth, such as the interdental and gumline junction areas in an ideal case. Since pressurized water and air channels are built into the mouthguard they mix to deliver the micro-scale mist at each outlet.

The variable flow rates from the console to the mouthguard are: water: 20-90 ml/min; air: 40-60 L/min. Thus, to generate the micro-scale mists, each outlet expects to have water at 1-20 ml/min and air at 0.5-40 L/min. The size of the micro-scale mists is 10-40 microns in diameter.

The mouthguard may be 3D printed so as to be customized for each user. The operation can simply be the process of: 1) getting an impression of the teeth of the user by impression materials or intraoral scanner; 2) designing and printing the mouthguard according to the impression case; 3) placing the mouthguard in the users’ mouth according to mandibular or maxilla positions; 4) pressing the on/off buttons on the console and 5) adjusting the flow rates of water and air to clean the initial plaque. Normally 10 seconds - 60 seconds is sufficient time to remove the initial plaque, depending on the oral health of the patient.

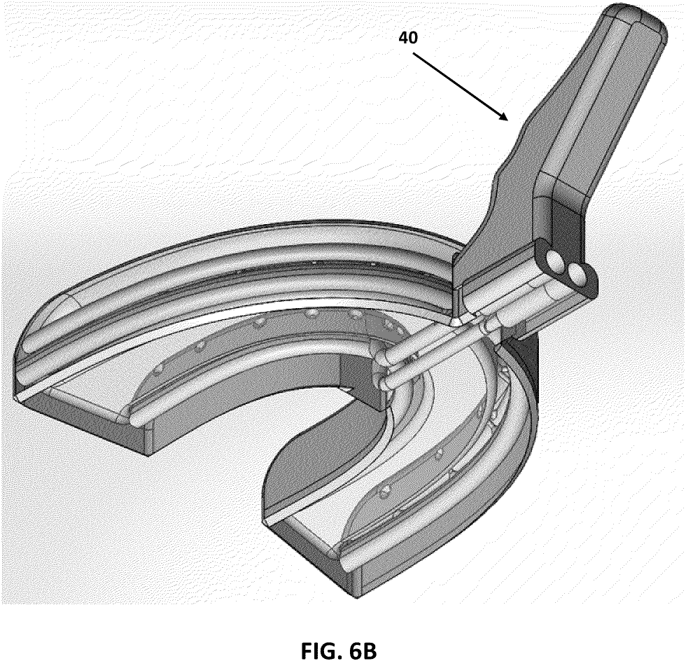

While the mouthguard can be placed in the mouth of the patient and held there by the care giver, it may be more convenient to have the mouthguard attached to the end of a horizontal arm of a support stand or handle 40 as shown in FIGS. 6A and 6B, and which is capable of holding it level and stationary at a convenient location for the patient. In this arrangement the care giver, instead of holding the mouth guard, can more easily hold the handle 40. Then, the patient only needs to bit down on the mouthguard for about a minute. Also, the end of the horizontal arm should be rotatable or the handle can be held upside down so that once the upper teeth are cleaned, the mouthguard can be rotated upside down to clean the bottom teeth.

Thus, the invention enables preliminary cleaning of dental plaque through a mouthguard device with multiple micro-scale mist outlets. Since the amount of water used is minimal, a suction source is not needed and the potential risk of choking, which may lead to fatal pneumonia of elderly patients caused by water accidentally get into trachea, is therefore reduced.

While the invention is explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

1. A micro-scale mist teeth cleaning device comprising:
a source of air under pressure;
a source of water under pressure; and
a mouthguard in the form of a generally semi-circular outer ridge and a generally semi-circular inner ridge with space in between for the teeth of a patient’s dental arch, said mouthguard farther including a two channel receptors for separately receiving the air and water under pressure and internal tubes for separately distributing the air under pressure and the water under pressure along the outer and inner ridges, the mouthguard further including openings along inner side of the outer ridge and the outer side of the inner ridge facing the location of the patient’s teeth when the mouthguard is installed in the patient’s mouth; and
wherein the tubes for the air and the water intersect at each opening at an angle such that they act to eject a micro-scale mist from the opening.

2. The micro-scale mist teeth cleaning device of claim 1 wherein the tubes for the air and the water intersect at each opening at an angle between 40° and 50° so as to create the micro-scale mist with particles of a size from 10-40 microns in diameter.

3. The micro-scale mist teeth cleaning device of claim 1 wherein the sources of air and water under pressure are contained within a console and wherein the amount of air and water pressure can be independently controlled by dials on the console.

4. The micro-scale mist teeth cleaning device of claim 3 wherein the console further contains push buttons that control the output of air and water under pressure either separately or together.

5. The micro-scale mist teeth cleaning device of claim 3 wherein the console further contains push buttons that separately turn on or off pressurized air and water generation.

6. The micro-scale mist teeth cleaning device of claim 3 further including dual channel tubes for separately conducting the air and water under pressure from the console to the receptor of the mouthguard.

7. The micro-scale mist teeth cleaning device of claim 1 further including a support stand or handle with a horizontal arm that supports the mouthguard while in the patient’s mouth cleaning one of the upper and lower rows of teeth, and that has a rotatable end or can be used upside down so that the mouthguard can be turned over to clean the other of the upper and lower rows of teeth.

8. The micro-scale mist teeth cleaning device of claim 4 wherein the variable flow rates from the console to the mouthguard are 20-90 ml/min for water and 40-60 L/min for air, which generate micro-mists at each outlet using 1-20 ml/min of water and 0.5-40 L/min of air.

9. The micro-scale mist teeth cleaning device of claim 1 wherein the air pressure and water pressure tubes in the inner and outer ridges of the mouthguard are located one above the other.

10. A method of micro-scale mist cleaning of the teeth of a patient comprising the steps of:
providing a mouthguard in the form of a generally semi-circular outer ridge and a generally semi-circular inner ridge with space in between for the teeth of a patient’s dental arch, said mouthguard farther including a two channel receptor for separately receiving the air and water under pressure and internal tubes for separately distributing the air under pressure and the water under pressure along the outer and inner ridge, the mouthguard further including openings along an inner side of the outer ridge and an outer side of the inner ridge facing the location of the patient’s teeth when the mouthguard is installed in the patient’s mouth, wherein the tubes for the air and the water intersect at each opening at an angle such that they act to eject a micro-scale mist from the opening;
placing the mouthguard in the users’ mouth according to one of the mandibular or maxilla positions;
turning on and adjusting the flow rates of water and air to clean the initial plaque for 10 to 60 seconds to cause a micro-scale mist to reach and clean the teeth;
stopping the flow rates and turning the mouthguard over;
placing the mouthguard in the users’ mouth according to the other of the mandibular or maxilla positions;
turning on and adjusting the flow rates of water and air to clean the initial plaque for an additional 0 to 60 seconds to cause a micro-scale mist to reach and clean the teeth.

11. The method of claim 10 wherein the mouthguard is customized to a particular patient and wherein the mouthguard is created by the steps of:
getting an impression of the teeth of the particular patient using impression materials or intraoral scanner;
designing the mouthguard according to the impression case; and
3D printing of the designed mouthguard.
